(19) United States
(12) Patent Application Publication
(10) Pub. No.: US 2026/0304016 A1
(43) Pub. Date: Oct. 1, 2026

(54) Microphone Boom Arm with Integrated and Detachable Ergonomic Grab Handle

(71) Applicant: Case Adam Hassak, Paramus, NJ (US)

(72) Inventor: Case Adam Hassak, Paramus, NJ (US)

(21) Appl. No.: 19/290,171

(22) Filed: Aug. 4, 2025

Related U.S. Application Data
(60) Provisional application No. 63/781,949, filed on Apr. 1, 2025.

(51) Int. Cl. H04R 1/08

(52) U.S. Cl. CPC H04R 1/08

(57) ABSTRACT

A microphone adjustment system includes an ergonomic grab handle configured to enable quiet repositioning of a microphone without direct contact with sensitive components such as the microphone body or shock mount. In various embodiments, the handle is (1) integrated into a stationary desktop-mounted boom arm, (2) mounted between the microphone and its support structure, or (3) attached directly to the microphone or its shock mount. The handle may include features such as an orientation interface, ergonomic contours, and vibration-dampening materials. The invention is particularly suited for streaming, podcasting, recording, and broadcasting environments where frequent and silent microphone adjustment is required during live use.

### CROSS-REFERENCE TO RELATED APPLICATION

This application claims the benefit under 35 U.S.C. § 119(e) of U.S. Provisional Patent Application No. 63/781,949, filed on Apr. 1, 2025, the entire contents of which are incorporated herein by reference.

### FIELD OF THE INVENTION

The present invention relates generally to microphone support systems, and more particularly to ergonomic adjustment mechanisms for repositioning microphones or similarly mounted components without transmitting mechanical noise or disturbing shock isolation. The invention comprises integrated or detachable handle assemblies configured to facilitate low-noise, user-friendly repositioning of a microphone support arm. Certain embodiments incorporate the handle into a desktop-mounted boom arm, while others implement a detachable accessory mounted between a microphone and its support structure. The invention is particularly applicable in professional and semi-professional audio environments such as streaming, podcasting, broadcasting, and recording.

### BACKGROUND OF THE INVENTION

Repositioning microphones silently and efficiently remains a longstanding challenge in streaming, podcasting, live broadcasting, and other real-time content creation environments. Desktop-mounted microphone boom arms are widely used to enable flexible microphone positioning during live use. However, users typically adjust the position by grasping the microphone body, shock mount, or arm components, which often results in unwanted handling noise, vibration transmission, or awkward movement during performance or recording.

While some handheld microphone grip solutions exist, such as the Auray GRIP Universal Microphone Pistol Grip and the RØDE PG2-R Pistol Grip with Shock Mount, these products are designed for mobile or field recording applications. The Auray GRIP is intended for use with boompoles, and the RØDE PG2-R is specifically designed for handheld operation with shotgun microphones. Although both incorporate ergonomic handling and vibration isolation features, neither is intended for, nor compatible with, desktop-mounted boom arm configurations. These solutions do not address the need for silent repositioning of microphones during live or studio use without disturbing orientation or compromising shock isolation.

Accordingly, there remains a need for an ergonomic handle or repositioning accessory specifically configured for use with desktop-mounted microphone boom arms. Such a device should allow users to make precise microphone adjustments without contacting acoustically sensitive components, thereby improving workflow, minimizing noise artifacts, and enhancing user experience in professional and semi-professional recording environments.

### SUMMARY OF THE INVENTION

The present invention provides a system and method for repositioning microphones in a quiet and ergonomic manner without requiring direct contact with sensitive microphone components. The invention includes various forms of grab handle assemblies designed for use with stationary microphone support systems, particularly desktop-mounted boom arms commonly used in streaming, podcasting, broadcasting, and recording environments.

In one embodiment, the handle assembly is positioned structurally between a microphone and its support arm, allowing users to reposition the microphone by gripping the handle instead of directly manipulating the microphone body or mount. In another embodiment, the handle is integrated into the distal end of a boom arm or other support structure, positioned adjacent to the microphone to enable silent adjustment. In a third embodiment, the handle is mounted directly to the microphone or its shock mount, either as a detachable accessory or as a fixed component.

The handle may include features such as an orientation interface that allows independent grip positioning, ergonomic contours, and vibration-dampening materials. These configurations reduce handling noise, improve user comfort and control, and preserve audio quality during live use. The handle may be implemented in various geometries, including straight, curved, C-shaped, or O-shaped designs, so long as the form allows ergonomic repositioning without requiring direct contact with sensitive microphone components. The invention addresses a significant need for precise, on-the-fly microphone adjustments in content creation environments while preserving the microphone's acoustic performance.

### BRIEF DESCRIPTION OF THE DRAWINGS

FIG. 1 is a perspective view of an attachable ergonomic microphone handle assembly, showing the handle mounted between a boom arm and a microphone.

FIG. 2 is a perspective view similar to FIG. 1, showing the handle and microphone repositioned to demonstrate adjustable movement.

FIG. 3 is an exploded view of the handle assembly, illustrating various internal and external components including mounting features, adjustment mechanisms, and connection interfaces.

FIG. 4 is a perspective view of an alternative embodiment of the microphone handle system, in which the ergonomic handle is integrated into the arm segment itself, rather than being a separate attachable component.

FIG. 5 is a perspective view of an ergonomic grab handle mounted directly to a microphone shock mount, illustrating a standalone repositioning accessory that allows for manual adjustment without contacting acoustically sensitive components.

### DETAILED DESCRIPTION OF THE INVENTION

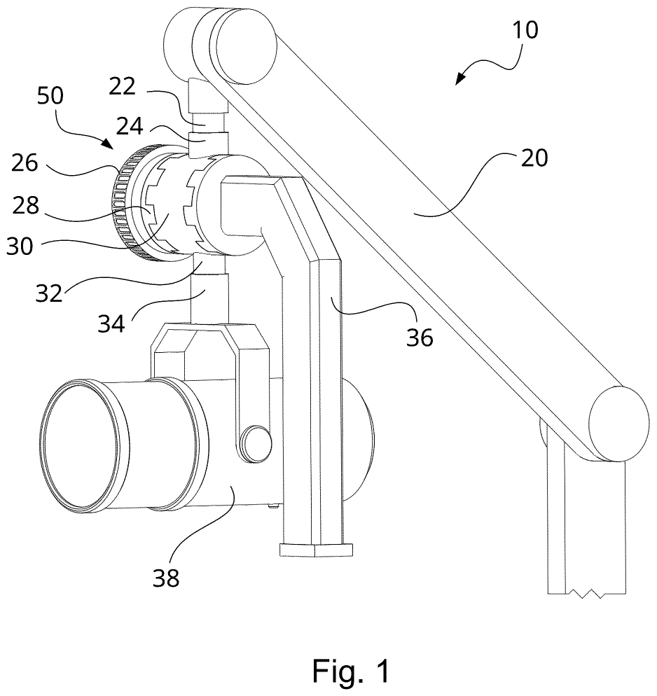

Referring to FIG. 1, the microphone boom arm system 10 includes a boom arm 20 configured to support a microphone 38 at one end. A detachable ergonomic grab handle 36 is mounted between the boom arm 20 and the microphone 38 via a modular handle assembly 50. The boom arm 20 connects to the handle assembly through a threaded boom arm screw head 22, which engages a handle attachment socket 24 located on the body of the assembly. A positioning ring 28 with circumferential notches is positioned adjacent to the socket 24 and held in place by a tightening knob 26. The notches on the ring engage matching projections or detents on the ergonomic handle 36, allowing the handle to be mounted on either side of the assembly to accommodate both left- and right-handed users. The handle is configured for manual gripping and enables the user to reposition the microphone silently without contacting acoustically sensitive components.

The microphone attachment portion 32 of the handle assembly 50 connects directly to a shock mount 34, which supports the microphone body 38. The ergonomic handle 36 extends outward from the handle assembly and is shaped to provide comfortable manual control. By adjusting the position of the handle and tightening the knob 26, users can lock the handle in a desired orientation. This modular arrangement improves workflow by enabling precise repositioning during live or recorded use without introducing handling noise.

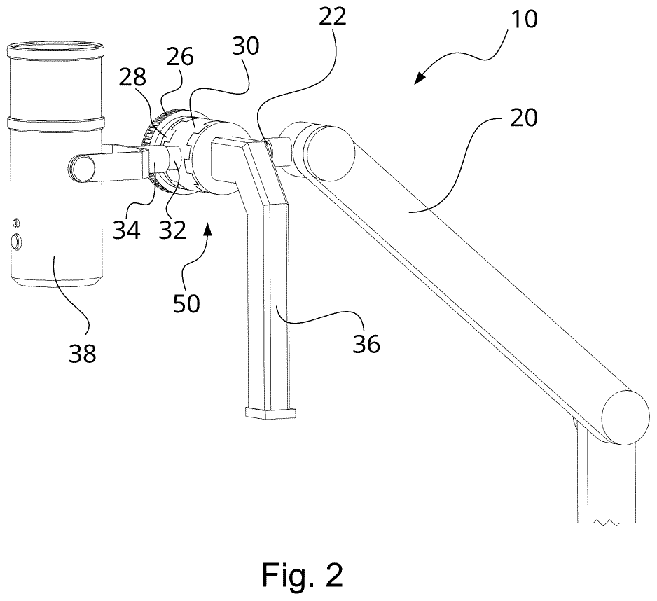

Referring now to FIG. 2, the microphone boom arm system 10 is shown in a repositioned configuration relative to FIG. 1. In this view, the ergonomic grab handle 36 and microphone 38 have been rotated to demonstrate how the orientation of the handle assembly 50 can be adjusted. The same structural components from FIG. 1 are present, including the boom arm 20, screw head 22, and handle components, but the handle 36 has been rotated to a new position. This configuration illustrates how a user can reposition the microphone and grab handle without disassembling the system, accommodating different user preferences or recording angles.

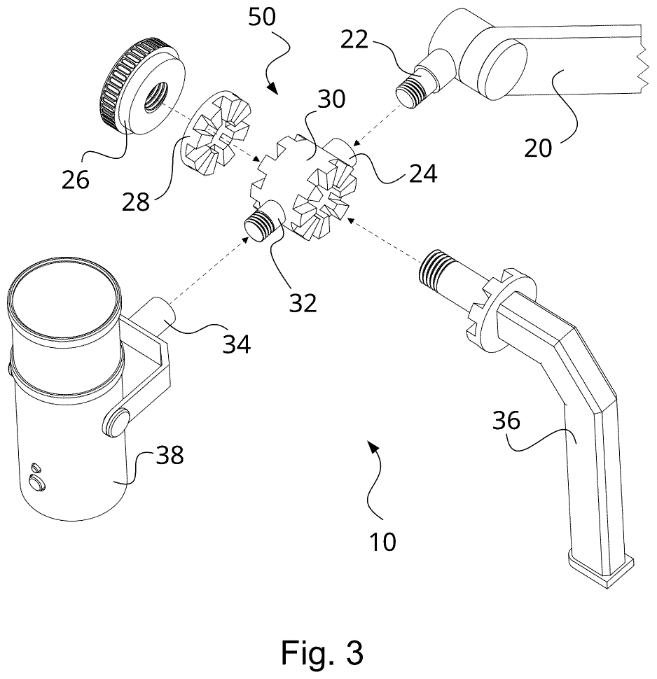

Referring to FIG. 3, an exploded view of the microphone boom arm system 10 is shown to illustrate the modular handle assembly 50 in greater detail. The boom arm 20 terminates in a threaded screw head 22, which is configured to engage a central socket 24 formed within a multi-sided coupling block 30. The coupling block 30 allows rotational adjustment of connected components. A positioning ring 28 with internal detents is aligned with the socket 24 and is configured to receive matching features from the ergonomic handle 36, enabling the handle to be mounted on either side of the block 30 for left- or right-handed use. The positioning ring 28 is secured by a tightening knob 26, which locks the handle 36 in the desired orientation when engaged. A microphone mount 32 extends from the opposite side of the coupling block 30 and connects to a shock mount 34, which supports the microphone 38. This exploded configuration demonstrates the modular and reconfigurable nature of the system, allowing for convenient assembly, disassembly, and user-specific orientation.

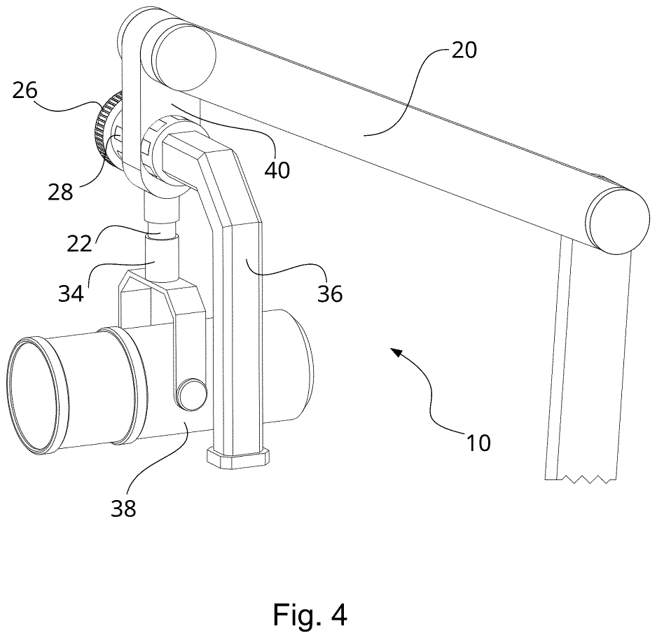

Referring to FIG. 4, an alternative embodiment of the microphone boom arm system 10 is shown, in which the ergonomic grab handle 36 is attached to an intermediate component 40 positioned at the distal end of the boom arm 20. In this embodiment, the intermediate component 40 provides a mounting interface for the handle 36 and may be fixed or pivotable relative to the boom arm 20. The handle 36 includes an angled extension configured to allow manual control of the microphone assembly. While shown here as a separate structure, the handle 36 may alternatively be formed integrally with the boom arm 20. This embodiment illustrates a configuration in which the handle is positioned directly adjacent to the microphone to enable user-initiated repositioning.

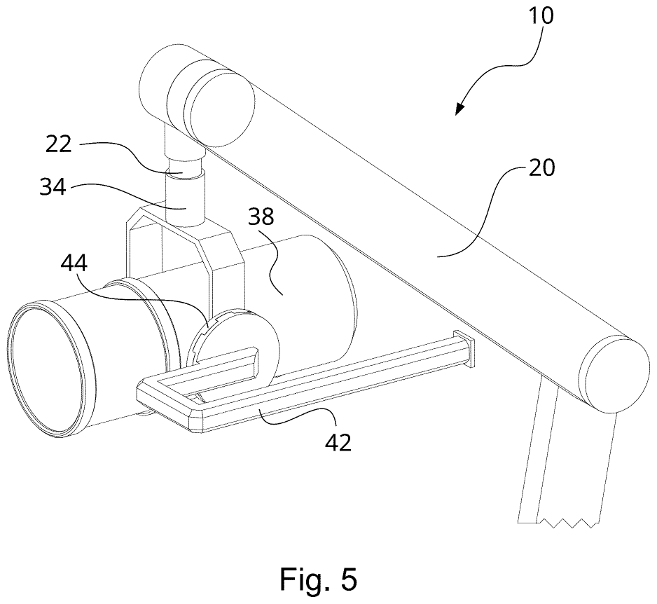

Referring to FIG. 5, another embodiment of the microphone boom arm system 10 is depicted, featuring a differently shaped ergonomic grab handle 42 mounted directly to the microphone shock mount 34 via an adjustable interface 44. In this embodiment, the boom arm 20 is coupled to the shock mount 34 through the screw head 22, while the microphone 38 is supported within the shock mount. The handle 42 is configured with an alternative geometry to suit specific user preferences and enables manual repositioning of the microphone assembly without direct contact with the microphone body 38 or other acoustically sensitive components.

The embodiments shown in FIGS. 1 through 5 collectively demonstrate multiple configurations of ergonomic grab handles that enhance manual control of a suspended microphone. These configurations may be modular, detachable, or integrated, and are designed to reduce handling noise and mechanical vibrations during microphone repositioning. The system provides adaptability for left- and right-handed users and addresses the needs of professional audio environments such as streaming, podcasting, broadcasting, and recording.

1. A detachable ergonomic microphone handle assembly, comprising: a grab handle configured for manual gripping and repositioning of a microphone; a first connector configured for attachment to a microphone support structure; a second connector configured for attachment directly or indirectly to a microphone or shock mount; wherein the grab handle is positioned to enable repositioning of the microphone without requiring direct manual contact with the microphone body or shock mount.

2. The system of claim 1, wherein the grab handle is configured to be mounted on either the left or right side of the assembly to accommodate user preference.

3. The system of claim 1, wherein the ergonomic grab handle includes an orientation interface allowing adjustment of the grab handle angle independently of the microphone orientation.

4. The system of claim 1, wherein the grab handle is composed of vibration-dampening or elastomeric materials.

5. The system of claim 1, wherein the grab handle includes ergonomic contours, textured surfaces, or grip-enhancing structures to improve tactile control and user comfort.

6. An ergonomic microphone boom arm system, comprising: an elongated boom arm configured to support a microphone at a distal end; an ergonomic grab handle integrated into or permanently affixed to a portion of the boom arm proximate to the microphone; wherein the grab handle is positioned to enable manual repositioning of the microphone without requiring direct contact with the microphone body or shock mount, thereby facilitating low-noise adjustment during live or recorded use.

7. The system of claim 6, wherein the grab handle is configured to be mounted on either the left or right side of the boom arm to accommodate user preference.

8. The system of claim 6, wherein the grab handle includes a pivot joint or orientation interface that allows the angle of the handle to be adjusted independently of the microphone orientation.

9. The system of claim 6, wherein the grab handle is composed of vibration-dampening or elastomeric materials.

10. The system of claim 6, wherein the grab handle includes ergonomic contours, textured surfaces, or grip-enhancing structures to improve tactile control and user comfort.

11. A microphone-mounted repositioning accessory, comprising: an ergonomic grab handle configured for manual gripping and adjustment of a microphone; at least one mounting interface configured to attach the grab handle directly to the microphone body or its shock mount; wherein the grab handle is positioned to enable repositioning of the microphone without requiring direct contact with acoustically sensitive components, thereby minimizing handling noise and preserving microphone isolation during adjustment.

12. The accessory of claim 11, wherein the grab handle is configured to be mounted on either the left or right side of the microphone or shock mount to accommodate user preference.

13. The accessory of claim 11, wherein the grab handle includes a pivot joint or orientation interface that allows the angle of the handle to be adjusted independently of the microphone orientation.

14. The accessory of claim 11, wherein the grab handle is composed of vibration-dampening or elastomeric materials.

15. The accessory of claim 11, wherein the grab handle includes ergonomic contours, textured surfaces, or grip-enhancing structures to improve tactile control and user comfort.
